(19) United States
(12) Patent Application Publication
(10) Pub. No.: US 2013/0216453 A1
(43) Pub. Date: Aug. 22, 2013

(54) System for Collecting and Containing a Fecal Sample

(71) Applicant: Wayne B. ELDRIDGE, San Antonio, TX (US)

(72) Inventor: Wayne B. ELDRIDGE, San Antonio, TX (US)

(21) Appl. No.: 13/593,090

(22) Filed: Aug. 23, 2012

Related U.S. Application Data
(60) Provisional application No. 61/526,488, filed on Aug. 23, 2011.

(51) Int. Cl. A61J 1/14

(52) U.S. Cl. CPC A61J 1/1412
USPC 422/550; 422/547

(57) ABSTRACT

A fecal collection device comprised of a single, double, or a triple elliptical (oval) collection tip contiguous with a shaft which is attached to a lid and a cylindrical container which attaches to the removable lid. Such a design enables medical personnel to safely and effectively obtain patient fecal samples. The design is simple, yet functional, allowing a more efficient collection method of fecal specimens for storage and transport to the testing laboratory.

### CROSS REFERENCES TO RELATED APPLICATIONS

This application claims the benefit under Title 35 United States Code §119(e) of U.S. Provisional Application 61/526,488 filed Aug. 23, 2011 the full disclosure of which is incorporated herein by reference.

### BACKGROUND OF THE INVENTION

1. Field of the Invention

The present invention relates generally to veterinary and human medical devices and instruments. The present invention relates more specifically to a device for the collection of a fecal sample from a patient (human or animal) for transfer in a sealed container to a laboratory for testing.

2. Description of the Related Art

A common diagnostic tool in both veterinary and human medicine is the collection and testing of fecal samples from patients to determine the presence or absence of parasites and other microbial infections. There are a number of fecal collection devices that have been utilized in the field, although each has one or more shortcomings that create problems for the patient and/or for the medical service provider collecting the sample. In general, existing fecal collection mechanisms require handling by medical personnel after collection and prior to the receipt of the sample by the laboratory for testing. This handling greatly increases the risk of infection to the handler as well as persons with whom they come into contact. Various other aspects to the geometry and structure of existing fecal collection mechanisms are detrimental to the comfort of the patient, as well as to the safety and comfort of the medical personnel collecting the sample and packaging it for transport to the testing laboratory.

Examples of efforts in the field to improve upon existing fecal collection mechanisms include those disclosed in U.S. Pat. No. 5,730,147 issued to Craig on Mar. 24, 1998 entitled Combined Thermometer and Fecal Sampling Apparatus. A further example of an effort to improve upon the basic device commonly utilized in the field is shown in U.S. Design Pat. No. D567,373 issued to Irby on Dec. 17, 2005 entitled Fecal Loop. The Irby disclosure generally shows the structure of a fecal collection device well know in the art improved upon by providing surface areas thereon with ridges, both in the loop component of the device and in the shaft handling component of the device.

Neither of the devices referenced above, nor any of the other efforts that have been made in the field, address the problems associated with immediately containing and transporting the fecal sample. It would be desirable, therefore, to have a device suitable for the collection of a fecal sample that could immediately be contained within the transport container so that the exposure of the sample to medical personnel is minimized. It would be desirable if the device was capable of obtaining a sample of sufficient size to allow appropriate analysis and testing of the sample to occur. It would be beneficial if the combination collection device and transport container could be integrated into a single unit that is easy to transport to the laboratory for testing. It would further be desirable if the collection device provided a geometry and a structure that lent some comfort to the patient during the collection of the fecal sample and yet remained easily manipulable by the medical personnel acquiring the fecal sample.

### SUMMARY OF THE INVENTION

In fulfillment of the above objectives, the present invention provides a fecal collection, containment, and transport device that includes a single, double, or a triple elliptical (oval) collection tip integrated onto a shaft that is positioned on and attached to a lid. The combination collection tip, shaft, and lid is configured to be inserted into and retained on a cylindrical container which includes a closed base and an open top which attaches to the removable lid. This design enables medical personnel to safely and effectively obtain patient fecal samples and to contain the same immediately after collection and during transport to a testing laboratory. The design is sized appropriately for most basic fecal collection routines and provides structures that benefit the comfort of the patient yet still provide an easily manipulable device by medical personnel.

### BRIEF DESCRIPTION OF THE DRAWINGS

FIG. 1A is a side view of a first embodiment of the present invention with a double loop showing the loops and shaft and their attachment to the container lid.

FIG. 1B is a side view of the embodiment of the present invention shown in FIG. 1A orthogonal to the view of FIG. 1A.

FIG. 2A is a side view of a second embodiment of the present invention with a single loop showing the loop and shaft and the attachment to the container lid.

FIG. 2B is a side view of the embodiment of the present invention shown in FIG. 2A orthogonal to the view of FIG. 2A.

FIG. 3 is a side view of the empty container without the lid, shaft, and loop component attached.

FIG. 4A is a side view of the container with the lid, shaft, and double loop structure of the first embodiment of the present invention as shown in FIGS. 1A & 1B.

FIG. 4B is a side view of the container with the lid, shaft, and single loop structure of the second embodiment of the present invention as shown in FIGS. 2A & 2B.

FIG. 5A is a top plan view of the container lid of the present invention (for either the first or second embodiment).

FIG. 5B is a bottom plan view of the loop, shaft, and container lid of the present invention (for either the first or second embodiment) without the container attached.

FIG. 6 is a bottom plan view of the loop, shaft, and container lid of the present invention, all positioned within the container.

FIG. 7A is a side view of a third embodiment of the present invention with a double loop showing the loops and shaft and their manner of attachment to the container lid.

FIG. 7B is a side view of the embodiment of the present invention shown in FIG. 7A orthogonal to the view of FIG. 7A.

FIG. 8 is a side view of a container appropriate for use in conjunction with the third embodiment of the present invention shown in FIGS. 7A & 7B.

FIG. 9 is a side view of the container shown in FIG. 8 with the third embodiment of the present invention as shown in FIGS. 7A & 7B positioned and retained therein.

FIG. 10A is a side view of a fourth embodiment of the present invention with a double loop, showing the loops and shaft integrated with the handling and attachment disc of the invention.

FIG. 10B is a side view of a fifth embodiment of the present invention with a double loop, showing the loops and an elongated shaft for use in conjunction with applications requiring greater sampling depths.

FIG. 11A is a side view of a sixth embodiment of the present invention with a triple loop showing the loops and shaft and their attachment to the container lid.

FIG. 11B is a side view of the container with the lid, shaft, and triple loop structure of the sixth embodiment of the present invention as shown in FIG. 11A.

### DETAILED DESCRIPTION OF THE PREFERRED EMBODIMENT

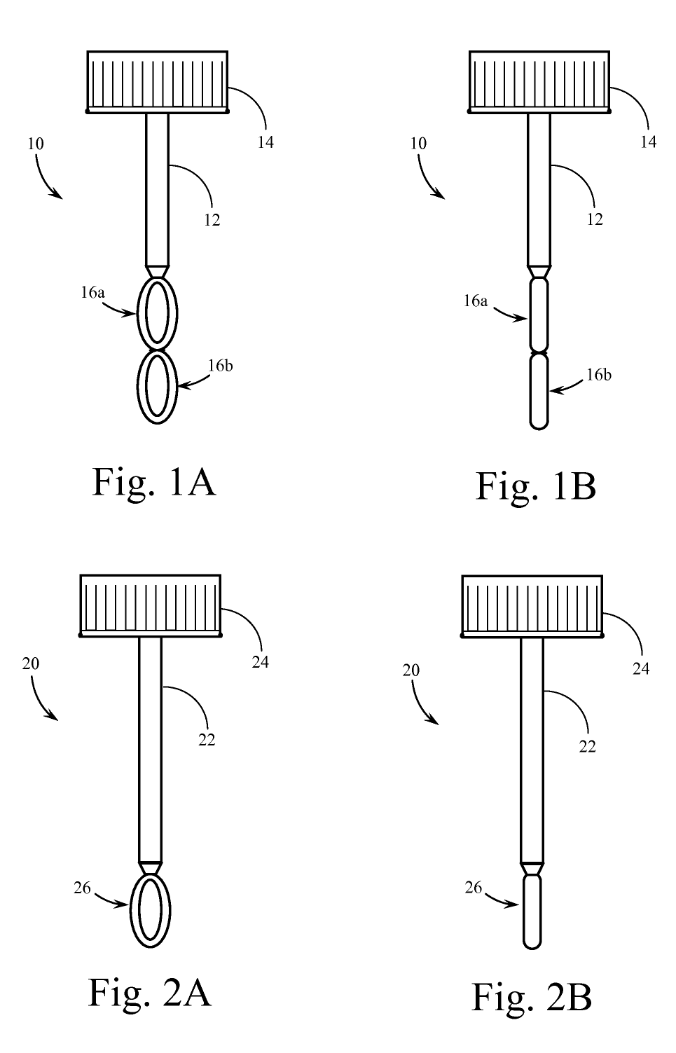

Reference is made first to FIG. 1A for a description of the basic components of the collection device of the present invention. Collection component 10 is made up primarily of shaft 12 preferably comprised of a rigid or semi rigid plastic or nylon material. Shaft 12 is positioned on and attached to lid 14. Extending from shaft 12 are, in a first preferred embodiment, a pair of oval or elliptical collection loops 16a and 16b. FIG. 1B discloses the same embodiment of the present invention shown in FIG. 1A but viewed in an orthogonal perspective.

The dual loop structure shown in the embodiment of FIGS. 1A and 1B provides a more than sufficient quantity of a fecal sample for most routine veterinary and medical testing requirements. The loops 16a and 16b are integrally formed into shaft 12 and extend therefrom. Shaft 12 is permanently attached to an interior surface of lid 14. Lid 14 in the preferred embodiment is a threaded cap or lid that may retain an internal flat disc (not shown) that itself is integrally molded into shaft 12. The placement of lid 14 over this portion of shaft 12 and the placement of the entire collection component 10 onto the container (described in more detail below) provides a secure mechanism that can easily be handled by medical personnel for the collection of an appropriate fecal sample from the patient.

Reference is now made to FIGS. 2A and 2B for a detailed description of an alternate preferred embodiment of the present invention replacing double collection loops 16a and 16b (shown in FIGS. 1A and 1B) with a single collection loop 26. The balance of the components in the component shown in FIGS. 2A and 2B remain the same. Collection component 20 is made up primarily of shaft 22 which is integrally formed with collection loop 26 and which is positioned within and retained by lid 24. FIG. 2B is a view of the same device shown in FIG. 2A but viewed in an orthogonal perspective.

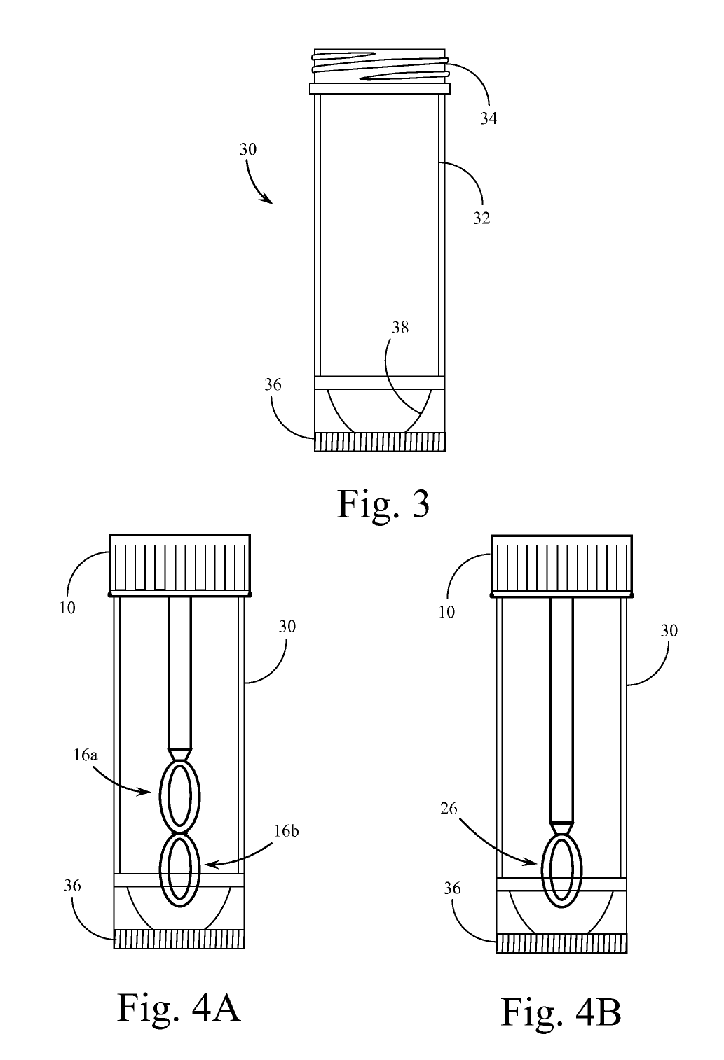

Reference is now made to FIG. 3 for a brief description of the cylindrical collection container component of the device of the present invention. Container component 30 is made up primarily of cylindrical body 32 having a threaded open end 34 and a manipulable closed end 36. Interior to container component 30 are sloped walls 38 at its base that facilitate the retention of the collected sample and its easy removal from the container.

In the preferred embodiment, container component 30 is a plastic bottle of a cylindrical configuration having a threaded top that matches with the internal threading of the lids shown in conjunction with FIGS. 1A and 1B, as well as FIGS. 2A and 2B. Referring to FIGS. 4A and 4B, the full assembly of the present invention is disclosed in each of the two referenced alternative embodiments. FIG. 4A discloses in detail the manner in which collection component 10 is inserted into and contained within container component 30. In this view, the base 36 of collection container 30 is shown to be formed with a ring of ridges that facilitates the attachment of container 30 to the lid of collection component 10. In this manner, medical personnel may easily close, tighten, and seal the collected fecal specimen within container 30 for transport to the testing laboratory. FIG. 4B discloses the similar manner in which container component 20 is inserted into, positioned within, and contained by container component 30. As indicated above, the use of a clear plastic material for the container component 30 allows easy visibility of the sample contained within and confirmation of the used or unused condition of the collection container.

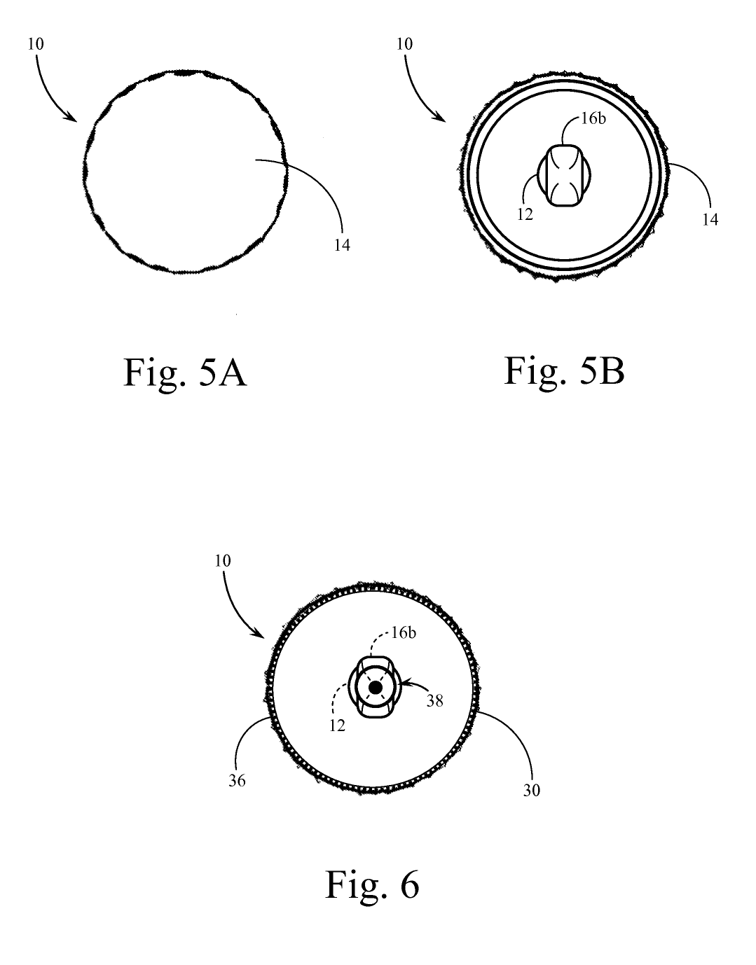

Reference is now made to FIGS. 5A and 5B for a top and bottom view of the collection component 10 (the example provided by the first embodiment of the present invention). In FIG. 5A the top of lid 14 is shown to include a radial array of ridges that facilitate the user's manipulation of the lid both in collecting the fecal sample and in positioning it and retaining it within the container component of the assembly. FIG. 5B discloses in detail a bottom view of the collection component 10 showing the interior portion of lid 14 as well as shaft 12 extending from the interior of lid 14. Also shown is the approximate cross-sectional structure of loop 16b which is integrally formed onto shaft 12.

Reference is next made to FIG. 6 for a bottom plan view of the loop, shaft, and container lid of the present invention, all positioned within the container component. In this view, the perimeter of lid 14 is seen as the outer extent of collection component 10. The cylindrical wall of container component 30 is likewise seen. The radial array of ridges 36 formed on the base of container component 30 is also shown in this view. Interior to these structures (viewed through the clear walled components of container 30) are shaft 12 and loop 16b now positioned within container component 30. Also seen in this view is the apex of the sloping bottom walls 38 of container 30 which, as described above, facilitate the maintenance and removal of the collected fecal sample from the container at the testing laboratory.

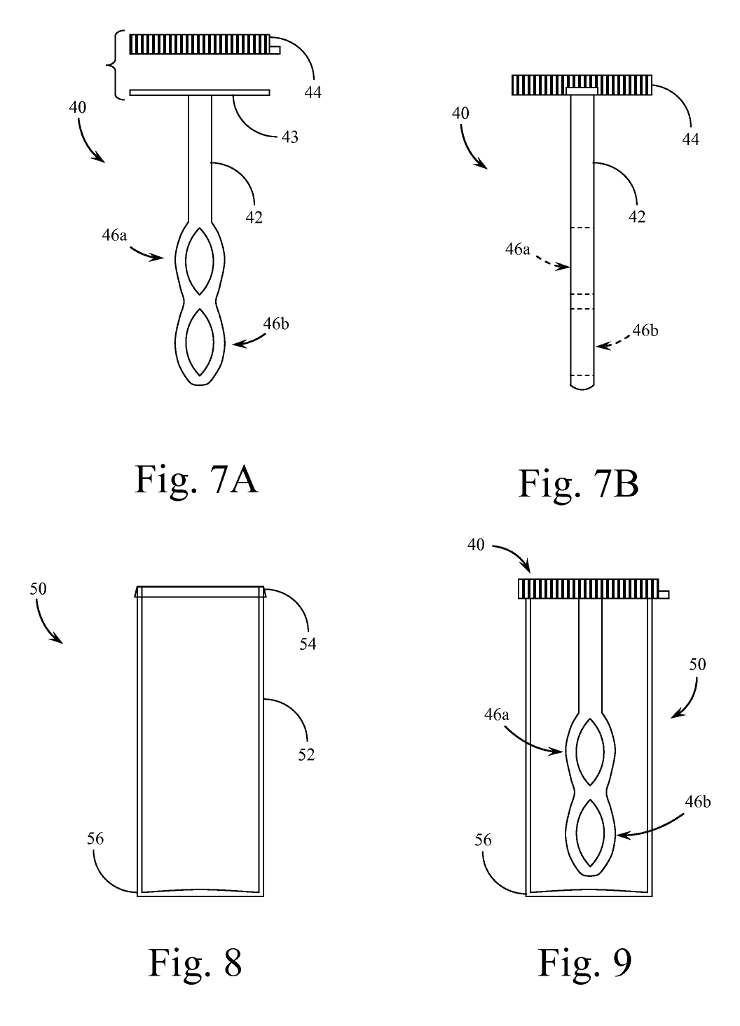

Reference is next made to FIGS. 7A & 7B for a description of the basic components of a third preferred embodiment of the collection device of the present invention. Collection component 40 in this case is made up primarily of shaft 42 preferably comprised of a rigid or semi-rigid plastic or nylon material. Shaft 42 is positioned on and attached to handling and attachment disc 43. Extending from shaft 42 are a pair of oval or elliptical collection loops 46a and 46b. Lid 44 is shown positioned adjacent disc 43 in a manner suitable for its assembly with collection component 40. The embodiment shown in FIGS. 7A & 7B is similar in some respects to the first embodiment shown and described above in conjunction with FIGS. 1A & 1B. Rather than being incorporated into the lid, however, this third preferred embodiment utilizes handling and attachment disc 43 that is permanently affixed to shaft 42 and is insertable within a standard sized bottle lid 44. In this manner, the product of the device of the present invention may be manufactured as a separate component that may then be used in conjunction with standard sized and readily available containers in a manner that carries out the same functionality associated with the first and second preferred embodiments of the present invention.

FIG. 7B discloses in detail the assembled collection component 40 showing cap 44 fixed onto and over the attachment disc (not shown in this view). Extending from this assembly is shaft 42 with a side view of collection loops 46a and 46b (shown in dashed lines through the width of shaft 42). In addition to the manner of attaching the lid, this third preferred embodiment of the present invention utilizes a collection component having a wider set of collection loops. Best seen in the view of FIG. 7B these wider collection loops, while retaining essentially the same diameter for shaft 42, offer a larger volume within which to retain a specimen sample.

Reference is next made to FIGS. 8 & 9, which show the manner of utilizing a standard bottle container suitable for having lid 44 attached thereto, and for retaining the collection component 40 therein for sample containment and transport. FIG. 8 discloses the basic components of bottle 50 having cylindrical sidewalls 52, cap retention rim 54, and base 56. FIG. 9 shows the full assembly of the components described above with bottle 50 retaining collection component 40 fully therein above base 56. Once again, the third preferred embodiment of the present invention allows for the manufacture and sale of a device that may be incorporated into the structures and geometries of standard press cap bottle configurations, thereby achieving the full functionality of the present invention for sample storage and transport.

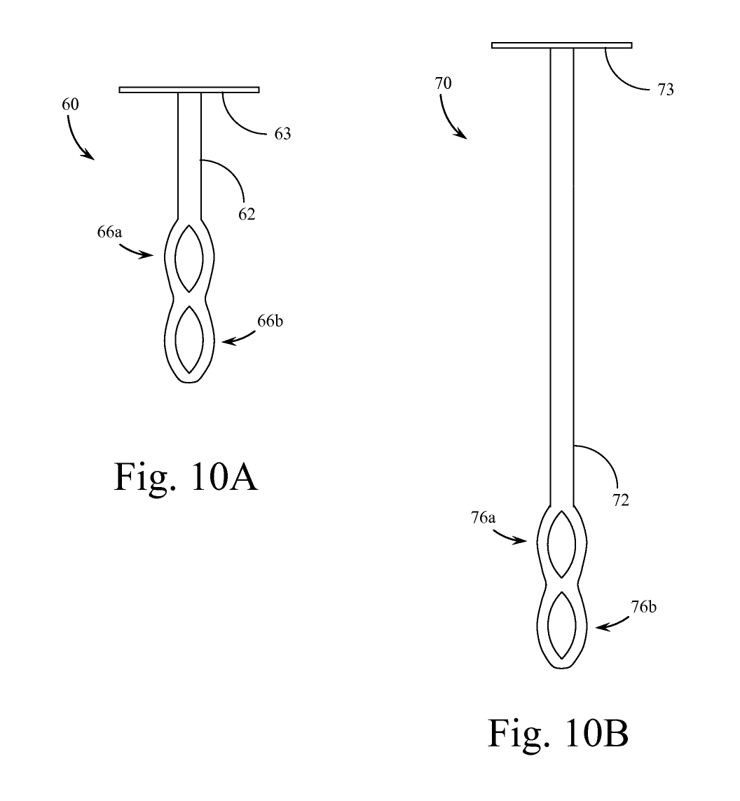

FIG. 10A represents the basic product construction comprising the fourth embodiment of the present invention providing a collection component 60 made up primarily of shaft 62, once again preferably comprising rigid or semi-rigid plastic or nylon material. Shaft 62 is positioned on and extends from handling and attachment disc 63. Extending in an opposite direction on shaft 62 are a pair of oval or elliptical collection loops 66a and 66b. Once again, use of the product shown as collection component 60 in FIG. 10A would be made in conjunction with standard sized sample or collection bottles having press fit lids as described above.

Reference is next made to FIG. 10B which represents a fifth preferred embodiment of the present invention providing a deeper collection depth for securing the sample specimen for testing. Collection component 70 is again made up primarily of shaft 72 which in this embodiment represent a shaft length three to four times greater than that shown in the embodiment of FIG. 10A. The balance of the components including handling and attachment disc 73, and elliptical collection loops 76a and 76b, are similar to their counterpart components in the fourth preferred embodiment shown in FIG. 10A. The embodiment shown in FIG. 10B represents a device that might be better suited for larger animals in a veterinary environment where accurate and representative specimen samples might not be obtained without reaching to a greater depth within the animal. Containment of a specimen thus acquired with the embodiment shown in FIG. 10B may be carried out with a correspondingly larger container of the type shown in FIG. 8 having a length commensurate with the length of collection component 70. The lid associated with such a container would, of course, match the diameter of attachment disc 73 and need not be larger in general than the structures associated with the above described shorter collection components.

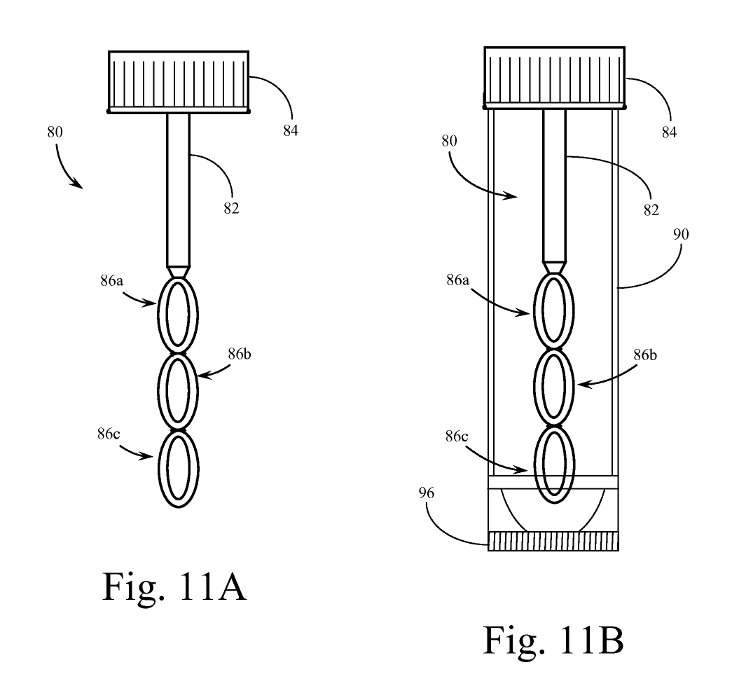

Reference is next made to FIGS. 11A & 11B which represent a sixth preferred embodiment of the present invention providing an even deeper collection depth for securing the sample specimen for testing. Collection component 80 is made up primarily of shaft 82 preferably comprised of a rigid or semi rigid plastic or nylon material. Shaft 82 is positioned on and attached to lid 84. Extending from shaft 82 are, in this sixth preferred embodiment, a triplet of oval or elliptical collection loops 86a, 86b, and 86c.

The triple loop structure shown in the embodiment of FIGS. 11A and 11B provides a further quantity of a fecal sample for most larger veterinary and medical testing requirements. The loops 86a, 86b, and 86c are integrally formed into shaft 82 and extend there from. Shaft 82 is permanently attached to an interior surface of lid 84. Lid 84 in the preferred embodiment is a threaded cap or lid that may retain an internal flat disc (not shown) that itself is integrally molded into shaft 82. The placement of lid 84 over this portion of shaft 82 and the placement of the entire collection component 80 onto the container (described in more detail below) provides a secure mechanism that can easily be handled by medical personnel for the collection of a larger fecal sample from the patient.

FIG. 11B discloses in detail the manner in which collection component 80 is inserted into and contained within container component 90. In this view, the base 96 of collection container 90 is shown to be formed with a ring of ridges that facilitates the attachment of container 90 to the lid of collection component 80. In this manner, medical personnel may easily close, tighten, and seal the collected fecal specimen within container 90 for transport to the testing laboratory.

Although the present invention has been described in terms of the foregoing preferred embodiments, this description has been provided by way of explanation only, and is not intended to be construed as a limitation of the invention. Those skilled in the art will recognize modifications of the present invention that might accommodate specific medical or veterinary patient characteristics and medical environments. Variations on the length of the shaft and the number of collection loops as described above are all considered to fall within the spirit and scope of the invention. Likewise, the dimensions associated with the container itself, although configured to adapt to the size and structure of the collection component, could likewise facilitate use of the present invention in a variety of other medical and patient environments. Such modifications as to configuration and even structure, where such modifications are coincidental to the type of patient involved and the medical environment wherein the collection of the sample is being carried out, do not necessarily depart from the spirit and scope of the invention.

I claim:

1. A device for the collection, containment, and transport of a fecal sample in human or veterinary medicine, the device comprising;
a collection component, the collection component comprising:
a shaft having a proximal end and a distal end;
one or more collection loops extending from distal end of the shaft;
a lid positioned on the proximal end of the shaft; and
a container component configured to receive the collection component, the container component comprising a cylindrical shell closed at a first end thereof and open at a second end thereof, the collection component insertable into the container component by way of the open end and being configured to receive and retain the lid of the collection component so as to fully enclose the one or more collection loops and the shaft within the container component.

2. A device for the collection, containment, and transport of a fecal sample in human or veterinary medicine, the device comprising;
a collection component, the collection component comprising:
a shaft having a proximal end and a distal end;
one or more collection loops extending from the distal end of the shaft; and
an attachment disc positioned on the proximal end of the shaft wherein the attachment disc has a diameter suitable for insertion into and retention by the press fit lid of a standard sized sample bottle.
